(19) United States
(12) Patent Application Publication
(10) Pub. No.: US 2013/0111914 A1
(43) Pub. Date: May 9, 2013

(54) AIRCRAFT IGNITION SYSTEM AND METHOD OF OPERATING THE SAME

(71) Applicant: Steve J. Kempinski, Seneca, SC (US)

(72) Inventor: Steve J. Kempinski, Seneca, SC (US)

(73) Assignee: CHAMPION AEROSPACE LLC, Liberty, SC (US)

(21) Appl. No.: 13/459,053

(22) Filed: Apr. 27, 2012

Related U.S. Application Data
(60) Provisional application No. 61/479,684, filed on Apr. 27, 2011.

(51) Int. Cl. F02C 7/266

(52) U.S. Cl. CPC F02C 7/266
USPC 60/772; 60/39.821; 60/39.827

(57) ABSTRACT

An aircraft ignition system having a power circuit, a control circuit, and a discharge circuit and coupled to the spark plugs of an aircraft engine. The power circuit may include two independent power sources; e.g., alternator power (such as a permanent magnet alternator) and power from aircraft or DC power bus. The control circuit may control one or more aspects of the discharge circuit, e.g., the ignition timing. And the discharge circuit may trigger a capacitive discharge ignition event to the spark plugs.

### CROSS-REFERENCE TO RELATED APPLICATION

This application claims the benefit of U.S. Provisional Patent Application No. 61/479,684, filed Apr. 27, 2011, the complete contents of which are hereby incorporated by reference.

### TECHNICAL FIELD

This invention relates to aircraft ignition systems.

### BACKGROUND OF THE INVENTION

Aircraft electrical power systems may include some degree of redundancy to protect against a single point failure. Power systems may include mission critical systems such as an ignition system that provides electrical power to fire the spark plugs used within a piston aircraft engine and that includes a control system to regulate the timing thereof. This redundancy increases the reliability of the system.

### SUMMARY OF THE INVENTION

In accordance with one aspect of the invention, there is provided an aircraft ignition system having a power circuit which includes a first power source and a second power source, a control circuit, and a discharge circuit. The power circuit may be coupled to the control circuit and the discharge circuit. And the control circuit may include at least one engine sensor for determining engine speed. Power may be provided by the first power source when the engine speed is at or below an engine speed threshold and may be provided by the second power source when the engine speed is above the engine speed threshold.

In accordance with another aspect of the invention, there is provided a method for operating an aircraft ignition system. The steps of operating the system may include: receiving power from a first power source and a second power source; firing a plurality of spark plugs with the power from the first power source (the power from the first power source may be provided to the plurality of spark plugs via a plurality of power channels); and firing the same plurality of spark plugs with the power from the second power source. The power from the second power source may be provided to the same plurality of spark plugs via the same plurality of power channels.

In accordance with another aspect of the invention, there is provided an aircraft ignition system for use with a piston-power engine. The system may include an electrical circuit and a plurality of spark plugs. The electrical circuit may include a power circuit, a control circuit, and a discharge circuit. The power circuit may have two independent power sources—the first power source may include an aircraft bus and the second power source may include an alternator. The power circuit may be coupled to the control circuit, and the control circuit may have a plurality of engine sensors and a plurality of timing circuits. The power circuit also may be coupled to the discharge circuit, and the discharge circuit may have a plurality of charge pumps and a plurality of trigger circuits. In addition, each charge pump may drive a plurality of trigger circuits. The plurality of spark plugs may be located in different engine cylinders and coupled to the trigger circuits. The electrical circuit may operate in a first mode when the engine speed is within a first range of speeds and may operate in a second mode when the engine speed is within a second range of speeds.

### BRIEF DESCRIPTION OF THE DRAWINGS

Preferred exemplary embodiments of the invention will hereinafter be described in conjunction with the appended drawings, wherein like designations denote like elements, and wherein:

FIGS. 1A-1D together depict a block diagram of an exemplary aircraft ignition system that includes a power circuit, a control circuit and a discharge circuit;

FIGS. 2A-2B together form a schematic diagram of an exemplary power circuit that may be used with the aircraft ignition system of FIG. 1;

FIGS. 3A-3C together form a schematic diagram of an exemplary control circuit that may be used with the aircraft ignition system of FIG. 1;

FIG. 4 is a schematic diagram of an exemplary discharge circuit that may be used with the aircraft ignition system of FIG. 1; and

FIGS. 5A-C are flowcharts that illustrate an exemplary method of operation that may be used with the aircraft ignition system of FIGS. 1A-1D.

### DETAILED DESCRIPTION OF THE PREFERRED EMBODIMENTS

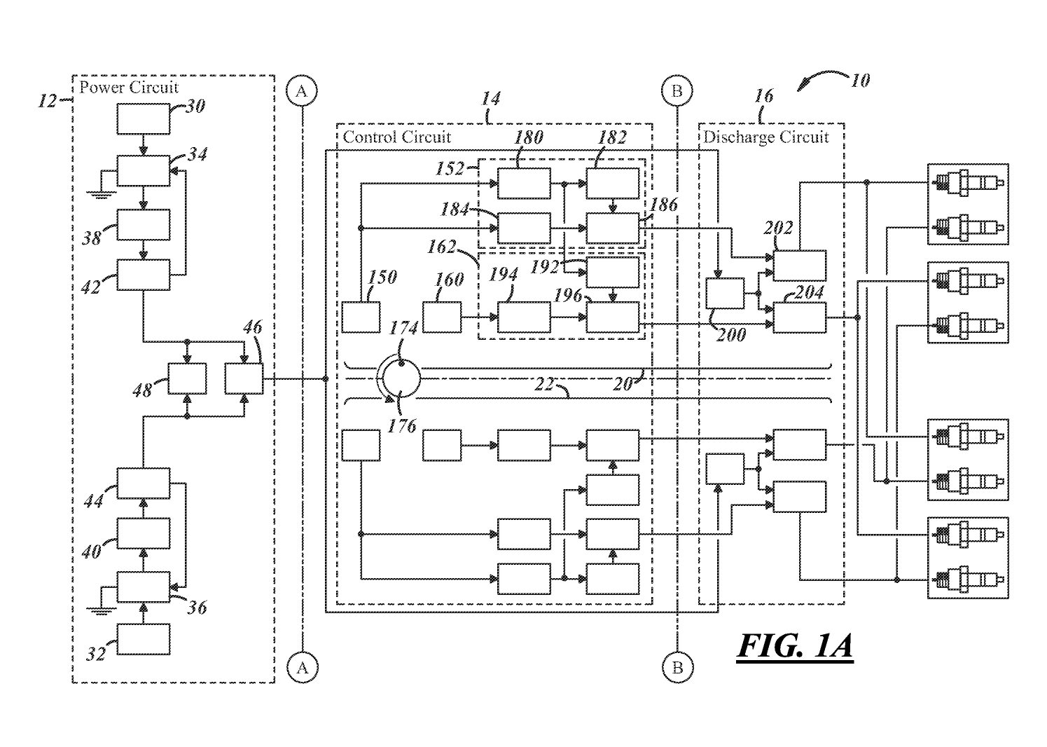

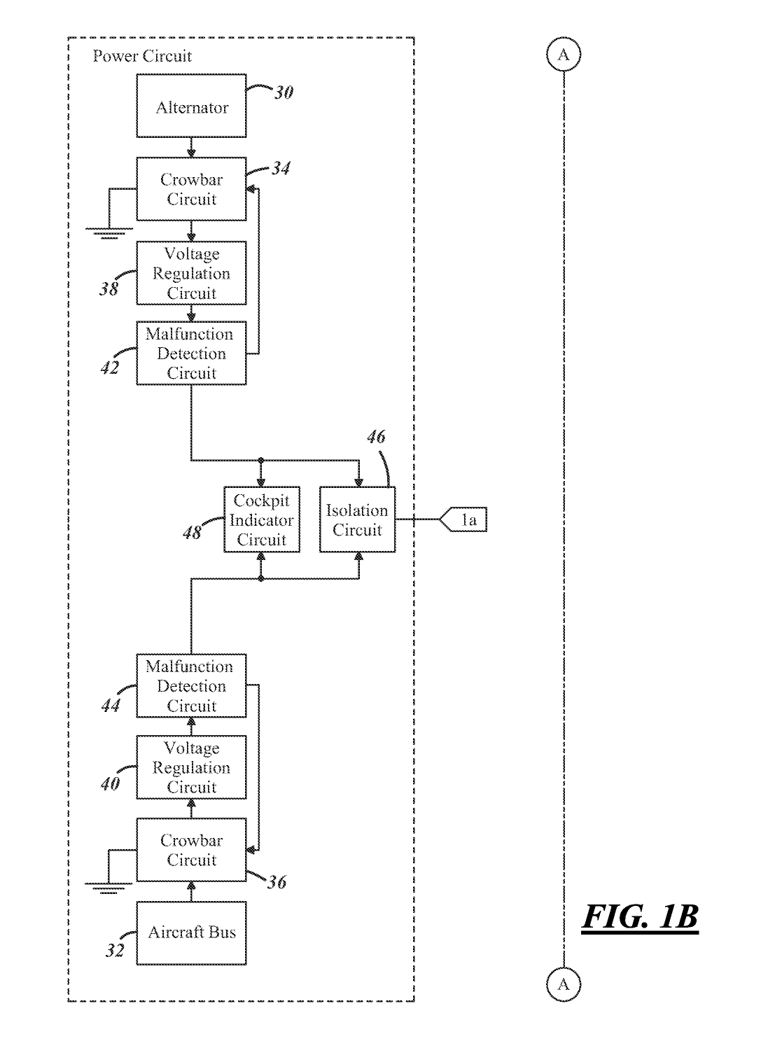

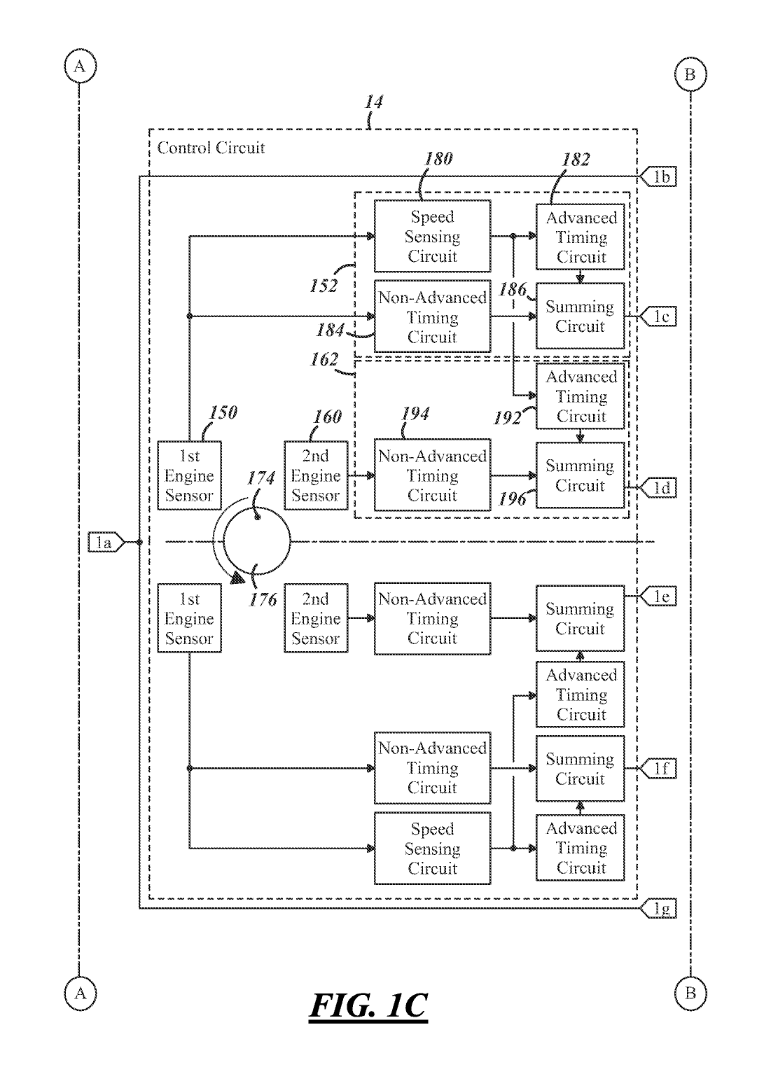

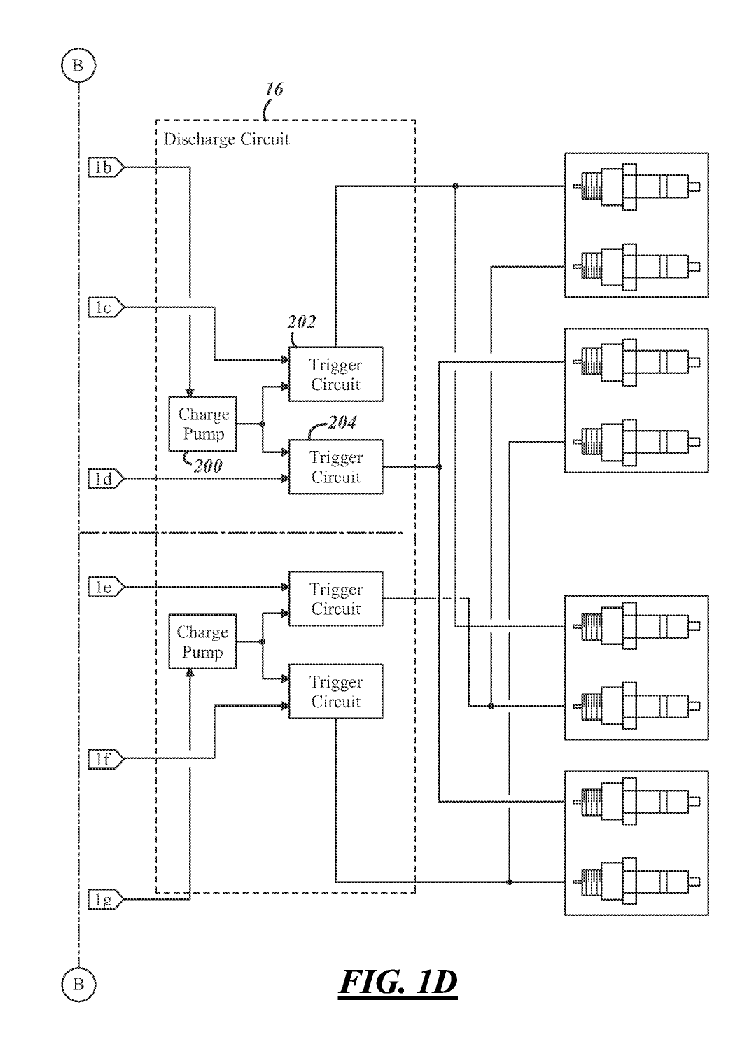

With reference to FIGS. 1A-1D, there is shown a block diagram of an exemplary aircraft ignition system 10 that includes a power circuit 12, a control circuit 14, and a discharge circuit 16. Generally speaking, aircraft ignition system 10 is a self-sustaining ignition system (SSIS) that uses redundant power sources to drive independent spark plugs in each of the cylinders of the engine. In an exemplary embodiment, aircraft ignition system 10 includes two separate and redundant power channels 20, 22, where each power channel provides electrical power over its own power delivery path and fires its own spark plugs. Although aircraft ignition system 10 is described below in the context of an exemplary four-stroke four-cylinder engine, it should be appreciated that the ignition system may be used with any aircraft utilizing an internal combustion or piston engine. This includes, for example, internal combustion engines having two, three, four, five, six or eight cylinders; engines that are naturally aspirated, turbo-charged or super-charged; engines that are two-stroke or four-stroke; small- or large-displacement engines; single-engine or multi-engine aircraft; as well as any other type of suitable application. Aircraft ignition system 10, as well as the exemplary method described below, is not limited to any particular type of aircraft or engine.

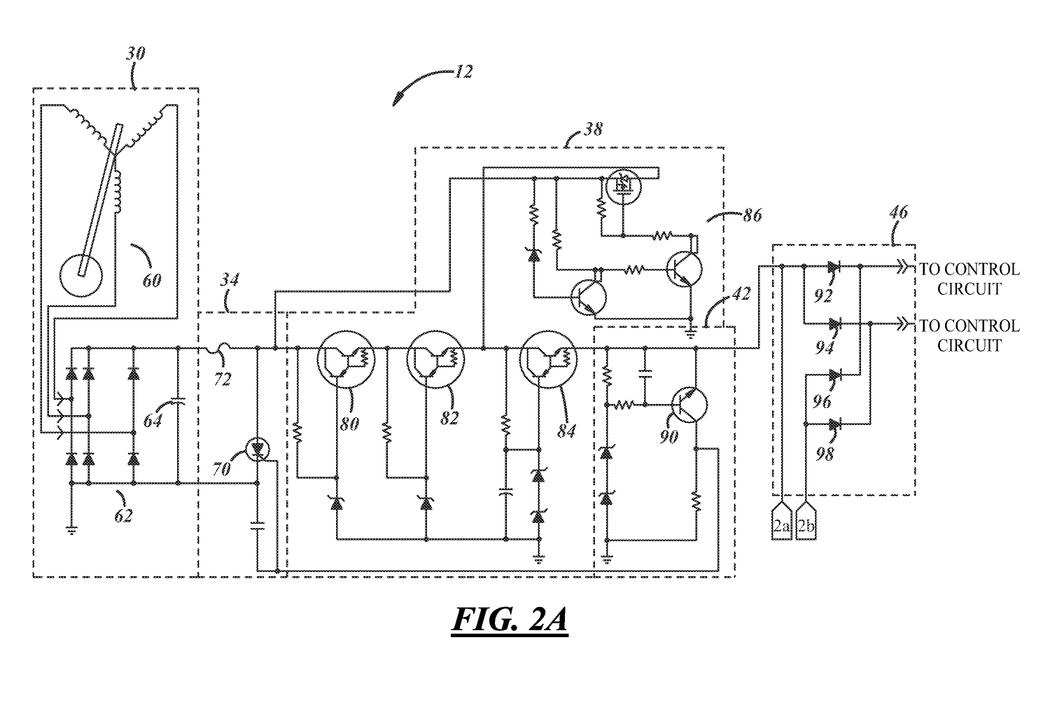

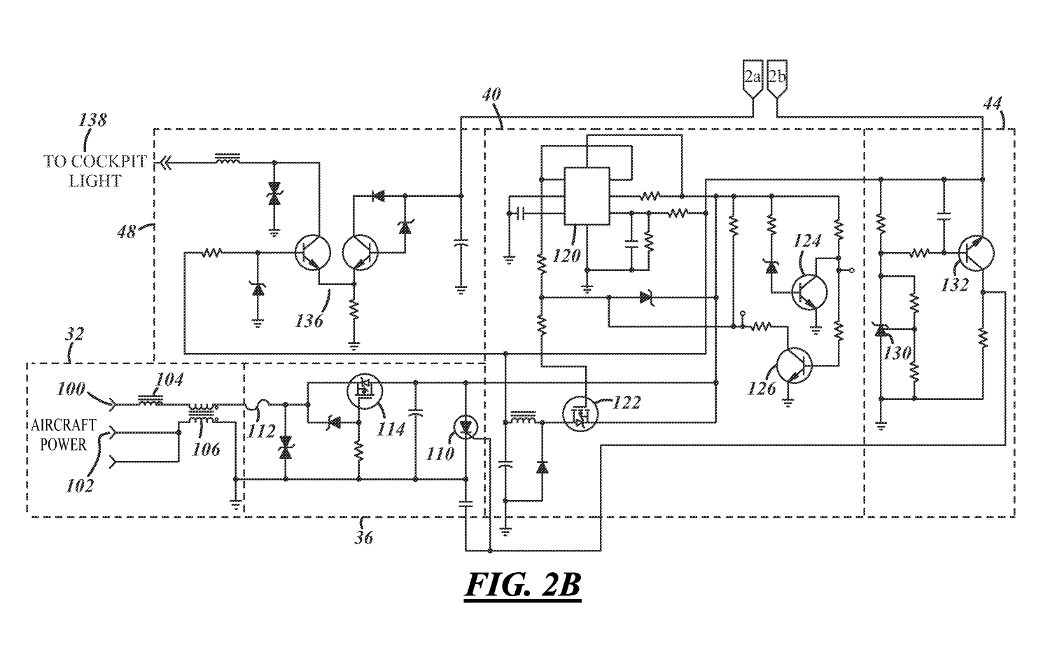

Power circuit 12 regulates or manages two or more redundant power sources and provides power output to control circuit 14 and/or discharge circuit 16. According to the exemplary embodiment shown here, power circuit 12 includes power sources 30, 32, crowbar circuits 34, 36, voltage regulation circuits 38, 40, malfunction detection circuits 42, 44, isolation circuit 46, and cockpit indicator circuit 48. According to the embodiment shown here, both of the power sources 30 and 32 separately generate and supply electrical power to isolation circuit 46, but only the electrical power with the higher voltage gets transmitted downstream to the rest of the aircraft ignition system 10. The following description of power circuit 12 refers to both the high-level block diagram of FIGS. 1A-1D, as well as the more detailed circuit schematic of FIGS. 2A-2B.

Power source 30 is one of the redundant sources of electrical power for aircraft ignition system 10 and, according to this particular embodiment, is an alternator. Skilled artisans will appreciate that a variety of different types of alternators may be used, including permanent magnet alternators (PMA) which utilize a rotating magnetic field to induce or generate electrical power. In an exemplary embodiment, power source 30 includes a three-phase PMA 60 coupled to a full-wave rectifier bridge 62. PMA 60 is mechanically coupled to and driven by the aircraft engine (not shown) and provides AC power to rectifier bridge 62, which rectifies it and provides DC power to crowbar circuit 34. Capacitor 64 is coupled to rectifier bridge 62 and helps smooth the DC power outputted by the rectifier bridge.

Crowbar circuit 34 is coupled between power source 30 and voltage regulation circuit 38, and helps prevent an overvoltage condition at the power source from damaging other circuits or portions of aircraft ignition system 10. If malfunction detection circuit 42 does not detect an overvoltage condition, then crowbar circuit 34 simply passes the DC power from power source 30 to voltage regulation circuit 38. However, if malfunction detection circuit 42 does detect an overvoltage condition, then it triggers crowbar circuit 34 and causes it to short power source 30 so that the voltage increase does not damage other downstream components of aircraft ignition system 10. According to an exemplary embodiment, crowbar circuit 34 includes a silicon controlled rectifier (SCR) 70 and a fuse 72. If power source 30 experiences an overvoltage condition, malfunction detection circuit 42 turns ‘on’ SCR 70 so that a low resistance ground path is created that short-circuits power source 30. The corresponding surge in electrical current causes fuse 72 to trip and helps prevent a single-point failure mode from occurring. Crowbar circuit 34 may be an active crowbar that removes or disengages the short-circuit once the overvoltage or transient event is over and restores the power circuit to normal operation; although, this is not necessary. Other types of suitable overvoltage protectors, such as voltage clamps and the like, may also be used in addition to or in lieu of the exemplary crowbar circuit shown here.

Voltage regulation circuit 38 is coupled between crowbar circuit 34 and malfunction detection circuit 42, and helps regulate or otherwise control the voltage that is provided to isolation circuit 46. In this particular embodiment, voltage regulation circuit 38 includes transistors 80-84 and a low voltage by-pass circuit 86. Transistors 80-84 are arranged as a series pass regulator that controls the voltage at the output of circuit 38 so that it is maintained or clamped at a relatively constant voltage level, such as 13.5 VDC. Skilled artisans will appreciate that when the permanent magnet alternator (PMA) 60 is spooling up charge, it can generate 60 V or more. Voltage regulation circuit 38 attempts to regulate or control this over-voltage condition, but if it is unable to reduce the voltage at its output, then malfunction detection circuit 42 will trigger crowbar circuit 34 in the manner already explained. Other types of voltage, current and/or power regulators and techniques for regulating or otherwise controlling the DC power may be employed, such as switching or shunt regulators.

Malfunction detection circuit 42 is coupled between voltage regulation circuit 38 and isolation circuit 46, and works with crowbar circuit 34 to help minimize the effects of an overvoltage condition or other malfunction with power source 30. In an exemplary embodiment, malfunction detection circuit 42 includes a transistor 90 that is coupled to both the output of voltage regulation circuit 38 and crowbar circuit 34. When an overvoltage condition occurs that is not remedied by voltage regulation circuit 38, the output of the voltage regulation circuit rises, transistor 90 is turned ‘on’, and a trigger signal is sent from transistor 90 to SCR 70 which causes the SCR to short-circuit power source 32, as already explained. Skilled artisans will appreciate that malfunction detection circuit 42 may include other features and/or other circuit arrangements. For instance, it is possible for crowbar circuit 34 to be more directly coupled to malfunction detection circuit 42 without the intervening voltage regulation circuit 38.

Isolation circuit 46 receives DC power from both power sources 30 and 32 and isolates or separates them by preventing current flow in unintended directions. According to an exemplary embodiment, isolation circuit 46 includes a diode steering array that has diodes 92-98 and selectively conveys power from only one of the two power sources 30, 32 to the rest of the aircraft ignition system 10. Diodes 92 and 94 are coupled to power source 30 at their anodes and to power source 32 at their cathodes; diodes 96 and 98 are coupled to power source 32 at their anodes and to power source 30 at their cathodes. When the electrical power provided by power source 32 has a higher voltage than that provided by power source 30 (such as when the engine is first started up), diodes 96, 98 convey the power from power source 32 to both downstream power channels 20 and 22. But when power source 30 provides the diode steering array with a higher voltage than power source 32 (such as when the engine reaches a certain RPM), then diodes 92, 94 convey or pass along the electrical power from power source 30 to both downstream power channels 20 and 22. Generally speaking, a handoff occurs from one power source to the other so that both power channels 20 and 22 are powered or driven by only one power source at a time; the power source that produces the highest voltage at isolation circuit 46. This handoff is described below in greater detail. In one embodiment, the output from power source 32 is purposely clamped at a lower voltage level (e.g., 12 VDC) than the output from power source 30 (e.g., 13.5 VDC) in an effort to influence or control the point at which the handoff occurs.

Power source 32 is the other redundant source of electrical power for aircraft ignition system 10 and, according to this particular embodiment, is the DC aircraft bus. In the particular arrangement shown here, power source 32 includes inputs 100, 102 which connect to the aircraft or DC power bus (e.g., a 12 VDC, 28 VDC or other voltage level bus) and inductive components 104, 106 for filtering. Skilled artisans will appreciate that the aircraft bus is typically coupled to one or more batteries and a standard alternator (not PMA 60), such that a steady supply of DC power is provided. Of course, other components, arrangement, techniques, etc. may be used to tie into or connect with the aircraft bus, as power source 32 is not limited to the specific embodiment shown here. It is even possible for an AC aircraft bus to be used, such is oftentimes the case on larger corporate jets.

Crowbar circuit 36 is coupled between power source 32 and voltage regulator 40, and prevents an overvoltage condition at the power source from damaging other circuits or portions of aircraft ignition system 10, much the same as crowbar circuit 34 described above. According to an exemplary embodiment, crowbar circuit 36 includes a silicon controlled rectifier (SCR) 110, a fuse 112 and a circuit protector 114 that prevents the battery from being hooked up backwards and damaging the aircraft ignition system 10. If there is a malfunction that results in an overvoltage condition, then malfunction detection circuit 44 triggers or turns ‘on’ SCR 110 which short-circuits power source 32. This may cause fuse 112 to trip and thereby protect the downstream components of aircraft ignition system 10. For more discussion of this circuit and its potential functionality, please see above.

Voltage regulation circuit 40 is coupled between crowbar circuit 36 and malfunction detection circuit 44, and helps regulate or otherwise control the voltage that is provided to isolation circuit 46. In this particular example, voltage regulation circuit 40 includes a switching regulator 120 and transistors 122, 124, 126, and the circuit is arranged as a series mode switch regulator that controls the voltage at the output of circuit 40 so that it is maintained at a relatively constant voltage level, such as 12.0 VDC. In this particular arrangement, voltage regulation circuit 40 provides power to isolation circuit 46 typically at a different voltage level (e.g., a lower voltage level) than does voltage regulation circuit 38, as already discussed. Voltage regulation circuit 40 has a different arrangement than voltage regulation circuit 38 in order to address fluctuations in voltage that emanate from the discharge circuit 16. More specifically, voltage fluctuations in discharge circuit 16 can work their way back through the system to power circuit 12 and have an effect on power sources 30 and 32. Because permanent magnet alternator 60 has a much higher internal resistance than aircraft bus 32, different voltage regulation circuits were employed to address these conditions. During engine start-up, aircraft bus 32 may not provide power at the full, normal voltage level (e.g., instead of providing 12 VDC, it may only provide 9 VDC or the like). When the DC power from power source 32 is below the normal level, transistors 124 and 126 turn ‘on’ transistor 122 and bypass switching regulator 120 as voltage regulation circuit 40 provides power to malfunction detection circuit 44. When the DC power from power source 32 is at or above the normal level, control of transistor 122 is turned over to switching regulator 120, which may use pulse-width modulation (PWM) or some other technique to control the operational state of transistor 122 and hence the power output from voltage regulation circuit 40. Other types of voltage, current and/or power regulators and techniques may be employed, as voltage regulation circuit 40 is not limited to the precise embodiment shown here.

Malfunction detection circuit 44 is coupled between voltage regulation circuit 40 and isolation circuit 46, and works with crowbar circuit 36 to help minimize the effects of an overvoltage condition or other malfunction with power source 32. In this particular example, malfunction detection circuit 44 includes a zener diode 130 and a transistor 132. When the DC output of voltage regulation circuit 40 exceeds the break over voltage of zener diode 130, transistor 132 turns ‘on’ and sends a trigger signal to SCR 110, thereby, activating crowbar circuit 36 and causing it to short-circuit power supply 32. Zener diode 130 may be a programmable zener diode with an adjustable break over voltage, however, this is not necessary.

Cockpit indicator circuit 48 is an optional feature that is coupled between the two different voltage regulation circuits 38 and 40, and informs the pilot as to which power source is currently powering or driving aircraft ignition system 10. In the exemplary embodiment shown in the drawings, cockpit indicator circuit 48 includes a differential amplifier 136 and a visual indicator 138. When the aircraft engine is initially started up, it is expected that the aircraft bus 32 will provide a higher voltage than that of the permanent magnet alternator (PMA) 30, which will not yet be rotating at a high rotational velocity. At this point, differential amplifier 136 provides a ground path for visual indicator 138, which may be an LED or the like, so that it alerts the pilot that DC aircraft bus 32 is powering aircraft ignition system 10. At some engine speed (e.g., around 750 RPM), it is expected that PMA 30 will produce a higher voltage than power bus 32; at which point, differential amplifier 136 no longer provides a ground path for LED 138 and thus turns the visual indicator ‘off’. Other arrangements and circuits may certainly be used to alert or otherwise notify the pilot as to which of the two redundant power sources is providing power, as cockpit indicator circuit 48 is only an exemplary embodiment.

Power circuit 12 provides control circuit 14 and/or discharge circuit 16 with DC power. When the voltage from power source 32 is higher than that from power source 30, as one would expect during engine start-up, isolation circuit 46 drives both power channels 20 and 22 with power from power source 32. When the voltage from power source 30 surpasses that from power source 32, as is typically the case after the engine has warmed up and the permanent magnet alternator (PMA) is rotating at a high rotational velocity, then isolation circuit 46 drives both power channels 20 and 22 with power from power source 30. In the exemplary embodiment shown here, power sources 30 and 32 are clamped or otherwise constrained at different voltage levels in order to manipulate or control the point at which power switches from aircraft bus 32 to PMA 60 (i.e., the point of “handoff”). Generally speaking, power channels 20 and 22 are only powered or driven by one power source at a time.

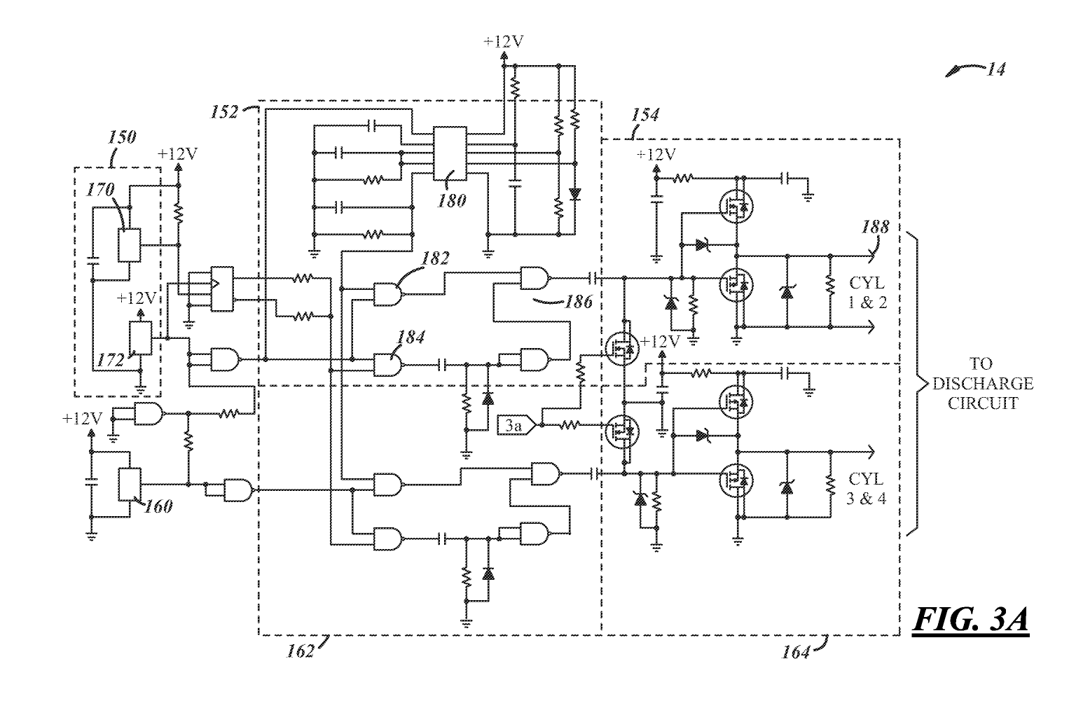

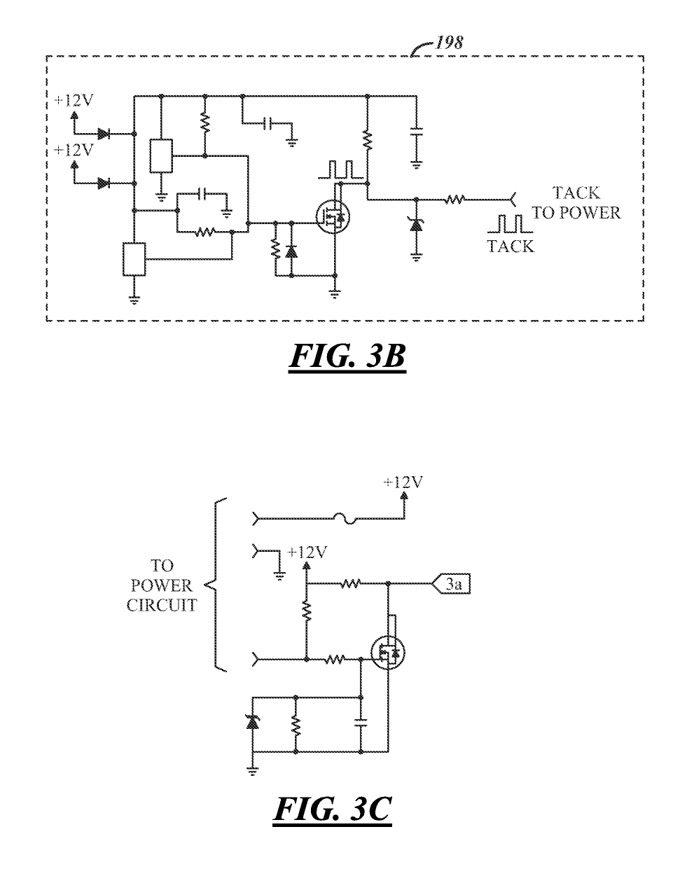

Control circuit 14 monitors the aircraft engine and controls one or more aspects of discharge circuit 16. According to the exemplary embodiment shown here, control circuit 14 controls the ignition timing of discharge circuit 16 without the use of a microprocessor, and includes components that are part of both power channels 20 and 22. In the schematic block diagram of FIGS. 1A-1D, the control circuit components located above the dashed line are part of power channel 20 and the control circuit components located below the dashed line are part of power channel 22. Power channels 20 and 22 are generally identical to one another. Thus, while the following exemplary description is in terms of power channel 20, which is shown in FIGS. 3A-3C, it should be understood that it applies equally to power channel 22, which is not shown in that figure. The upper power channel 20 of control circuit 14 includes a first engine sensor 150, a first timing circuit 152, and a first discharge circuit driver 154 for firing two of the four cylinders, and a second engine sensor 160, a second timing circuit 162, and a second discharge circuit driver 164 for firing the other two cylinders. The lower power channel 22, which is not part of FIGS. 3A-3C, includes similar components and redundantly fires the same four cylinders. The following description of control circuit 14 refers to both the high-level block diagram of FIGS. 1A-1D, as well as the more detailed circuit schematic of FIGS. 3A-3C.

First engine sensor 150 determines the position, speed, acceleration and/or direction of the engine and may include one or more sensing elements. According to the exemplary embodiment shown here, first engine sensor 150 includes a pair of Hall sensors 170, 172 which electromagnetically interact with a rotating magnetic element 174 attached near the perimeter of an engine crankshaft 176. Hall sensor 170 provides an output that is representative of the rotational direction of the engine, and Hall sensor 172 provides an output that is representative of the rotational speed of the engine. If Hall sensor 170 determines that the engine is rotating in the wrong direction, it sends an engine direction signal to flip-flop 174 which prevents aircraft ignition system 10 from firing the various spark plugs; that is, prevents the engine from operating in reverse. Hall sensor 172 provides an engine speed signal to first timing circuit 152.

First timing circuit 152 is coupled to first engine sensor 150 and controls the ignition timing for two of the four cylinders. According to one example, first timing circuit 152 generally includes a speed sensing component 180, an advanced timing component 182, a non-advanced timing component 184, and a summing circuit 186. Control circuit 14 is designed to operate on a leading edge of the output of Hall sensor 172 during periods of advanced timing (BTDC), and on a trailing edge of the output of Hall sensor 172 during periods of non-advanced timing (TDC or ATDC). According to this particular embodiment, Hall sensor 172 is coupled to and provides output to components 180, 182 and 184. Speed sensing component 180, which may include a frequency to voltage converter, is coupled to advanced timing component 182 and compares the current engine speed to some engine speed threshold. If the current engine speed exceeds the engine speed threshold, then speed sensing component 180 recognizes the high speed condition and enables advanced timing component 182 to contribute to the overall ignition timing so that a timing advance may occur (i.e., BTDC). If the current engine speed is less than the engine speed threshold, such as when the engine is just being started, then speed sensing component 180 prevents advanced timing component 182 from contributing to the overall ignition timing (also referred to as a “lock-out condition”); this results in non-advanced timing (e.g., TDC or ATDC).

Advanced and non-advanced timing components 182 and 184 may include one or more NAND gates, as well as any other suitable components. Advanced timing component 182 is coupled between speed sensing component 180 and summing circuit 186, while non-advanced timing component 184 is coupled between first engine sensor 150 and summing circuit 186. Skilled artisans will appreciate that when speed sensing component 180 senses a low speed condition, it locks out the advanced timing by providing a bit to an input of NAND gate 182 so that the NAND gate provides no output and summing circuit 186 only processes the output from non-advanced timing component 184. Conversely, when speed sensing component 180 senses a high speed condition, it enables advanced timing component 182 to provide summing circuit 186 with a timing advance, such as 20° BTDC, such that the summing circuit takes both the non-advanced and advanced timing into account.

Summing circuit 186 is coupled between advanced and non-advanced timing components 182, 184 at its input and discharge circuit driver 154 at its output. Depending on the particular embodiment used, summing circuit 186 may include one or more NAND gates, as well as other circuit components known in the art. It is not necessary for summing circuit 186 to be provided according to the particular arrangement shown in FIGS. 1A-1D, so long as the summing circuit is able to join, merge or otherwise combine the output from components 182 and 184. When the engine speed is below the engine speed threshold, summing circuit 186 is simply triggered with a trailing edge of the output of first engine sensor 150 (e.g., at TDC); and when the engine speed is at or above the engine speed threshold, summing circuit 186 is triggered with a leading edge of the first engine sensor output (e.g., at 20° BTDC).

Discharge circuit driver 154 is coupled to summing circuit 186 and may trigger a capacitive discharge ignition (CDI) event in discharge circuit 16. In the particular embodiment shown here, discharge circuit driver 154 includes an output 188 and several other components and is controlled by the output of summing circuit 186. Output 188 provides a trigger signal to discharge circuit 16 which initiates a capacitive discharge ignition (CDI) event, as is understood by those skilled in the art.

The second engine sensor 160, second timing circuit 162, and second discharge circuit driver 164 operate in largely the same way as corresponding devices 150, 152 and 154, as just described. One difference is that second engine sensor 160 is preferably circumferentially spaced from first engine sensor 150 by approximately 180° around the crankshaft 176 and corresponds to the firing location of the other two cylinders. As mentioned above, first timing circuit 152 is designed to fire two of the four cylinders while second timing circuit 162 is designed to fire the other two cylinders. Each firing cycle fires two cylinders at a time, where one of the cylinders receives a so-called “wasted spark.” For instance, first timing circuit 152 may fire cylinders one and two while second timing circuit 162 fires cylinders three and four; this assumes that cylinders one through four are each 180° apart from each other. First power channel 20 drives a total of four spark plugs, one in each of the four cylinders of the engine. The second power channel 22 (not shown in FIGS. 3A-3C) generally includes the same components as just described, except that power channel 22 drives four separate and redundant spark plugs. Accordingly, each cylinder includes two separate spark plugs, where one of the spark plugs is fired through power channel 20 and the other spark plug is fired through power channel 22.

Skilled artisans will appreciate that control circuit 14 may include a different combination of components and devices than those illustrated in FIGS. 1A-1D and 3A-3C, including combinations having more, less or different components than those shown. For example, control circuit 14 may include an optional tachometer circuit 198 which receives and processes data from one or more of the engine sensors and sends corresponding engine speed output to a tachometer. In another example, control circuit 14 may include one or more visual indicators that can inform or otherwise alert the pilot as to when the engine is operating according to a timing advance and when it is not, to cite just a few possibilities.

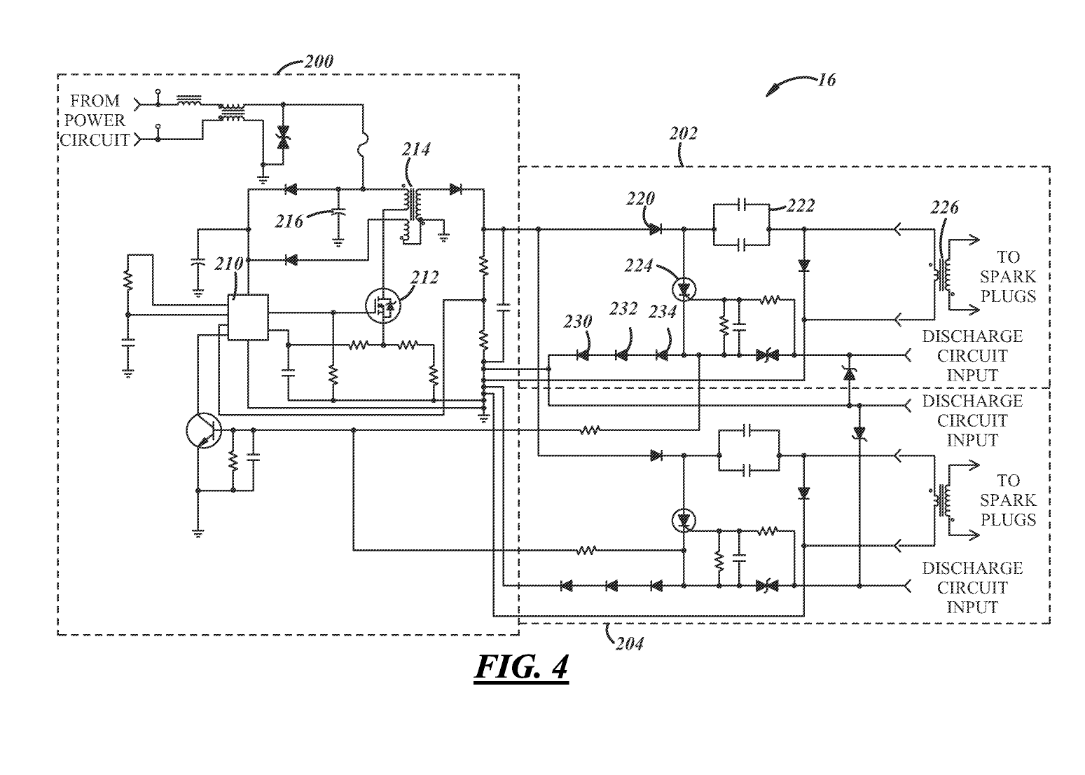

Turning now to FIG. 4, discharge circuit 16 receives power from power circuit 12, increases the voltage of the power through a capacitive discharge ignition (CDI) process, and fires the various spark plugs according to the ignition timing established by control circuit 14. In the exemplary embodiment shown here, discharge circuit 16 includes a charge pump 200, a first trigger circuit 202, and a second trigger circuit 204. As with the control circuit, discharge circuit 16 includes components that are part of first power channel 20 and second power channel 22. FIG. 4 only shows the first power channel portion of discharge circuit 16; the second power channel portion includes the same general combination of components and is not illustrated in that figure. Accordingly, the first power channel 20 includes one charge pump and two trigger circuits 202, 204, and the second power channel 22 also includes one charge pump and two trigger circuits. The following description of discharge circuit 16 refers to both the high-level block diagram of FIGS. 1A-1D, as well as the more detailed circuit schematic of FIG. 4.

Charge pump 200 is coupled to the output of power circuit 12, and is designed to step-up or otherwise increase the voltage of the power received from the power circuit. It should be appreciated that the actual power from power circuit 12 may be provided directly to discharge circuit 16 without passing through control circuit 14, or it may be provided indirectly through the control circuit. In the exemplary embodiment of FIG. 4, charge pump 200 is arranged as a flyback step-up transformer and includes a voltage comparator 210, a switch 212, a DC-DC converter 214, and a charge capacitor 216. The voltage comparator 210 monitors the voltage of the power provided by power circuit 12 and when the voltage exceeds a certain threshold, it sends an output to switch 212 thereby turning it ‘on’. Switch 212 is preferably a high current switch (e.g., 18 amps or more) that once turned ‘on’, connects the primary winding of DC-DC converter 214 with a low resistance ground path. This causes a sudden and significant surge in current that originates with charge capacitor 216 and flows through the primary winding of DC-DC converter 214, switch 212, and a pair of resistors to ground such that a high voltage is induced in the secondary winding of converter 214. The output of charge pump 200 feeds or provides power to two separate energy storage capacitors; one in each of the trigger circuits 202 and 204. In an exemplary embodiment, charge pump 200 steps-up the voltage from around 12-13.5 VDC to around 250 VDC and includes an additional winding that bootstraps in order to feed power to comparator 210. This bootstrapping can be particularly helpful when the DC bus goes low.

Trigger circuit 202 is coupled between charge pump 200 and two of the four cylinders. In one example, trigger circuit 202 receives stepped-up power from charge pump 200, stores the stepped-up power on a storage capacitor, and releases the stored power through a step-up transformer at a specific moment that is determined by control circuit 16. According to an exemplary embodiment, trigger circuit 202 includes a steering diode 220, one or more storage capacitors 222, an SCR 224, and a step-up transformer 226.

Steering diode 220 is coupled to and directs current from the secondary winding of DC-DC converter 214 to storage capacitors 222 so that charge can be built up on the parallel connected capacitors (these capacitors could be substituted for a single larger capacitor, for example). SCR 224 is coupled between storage capacitors 222 and ground so that when a trigger signal is received at its gate from control circuit 14, the switch turns ‘on’ and releases or discharges the energy stored on storage capacitors 222. This in turn causes a collapsing electromagnetic field in step-up transformer 226 and induces an even higher voltage pulse in the secondary winding, which is provided to two separate spark plugs. During the discharge of capacitors 222, a blanking pulse is generated across diodes 230-234 that blanks the DC-DC converter so that SCR 224 can recover or reset once the capacitors are discharged.

Trigger circuit 204 is arranged and operates largely the same as trigger circuit 202, except that it fires the other two cylinders when the engine rotates another 180° and does so according to a separate trigger signal from control circuit 16. Because of the similarity between trigger circuits 202 and 204, a separate description of circuit 204 has been omitted. The discussion above for circuit 202 equally applies to circuit 204 as well.

As mentioned above several times, there are two separate power channels 20, 22 which separately and redundantly provide power to the different cylinders of the engine. FIG. 4 only illustrates upper power channel 20; another equivalent power channel is included within discharge circuit 16, even though it is not illustrated in this drawing. Therefore, discharge circuit 16 includes a total of two charge pumps, four trigger circuits, and drives eight separate spark plugs in four cylinders. Of course, aircraft ignition system 10 could be modified to accommodate an engine with more or fewer cylinders than the exemplary four-cylinder engine used here. It should be appreciated that the drawings and descriptions previously discussed are only meant to illustrate some of the potential embodiments of aircraft ignition system 10, as that system is not strictly limited to those examples. For instance, the different dashed lines and boxes drawn around different combinations of components are not meant to be strict or specific boundaries or perimeters of the devices they represent. Rather, they are simply provided to help illustrate some of the different components, devices, sections, etc. of exemplary aircraft ignition system 10.

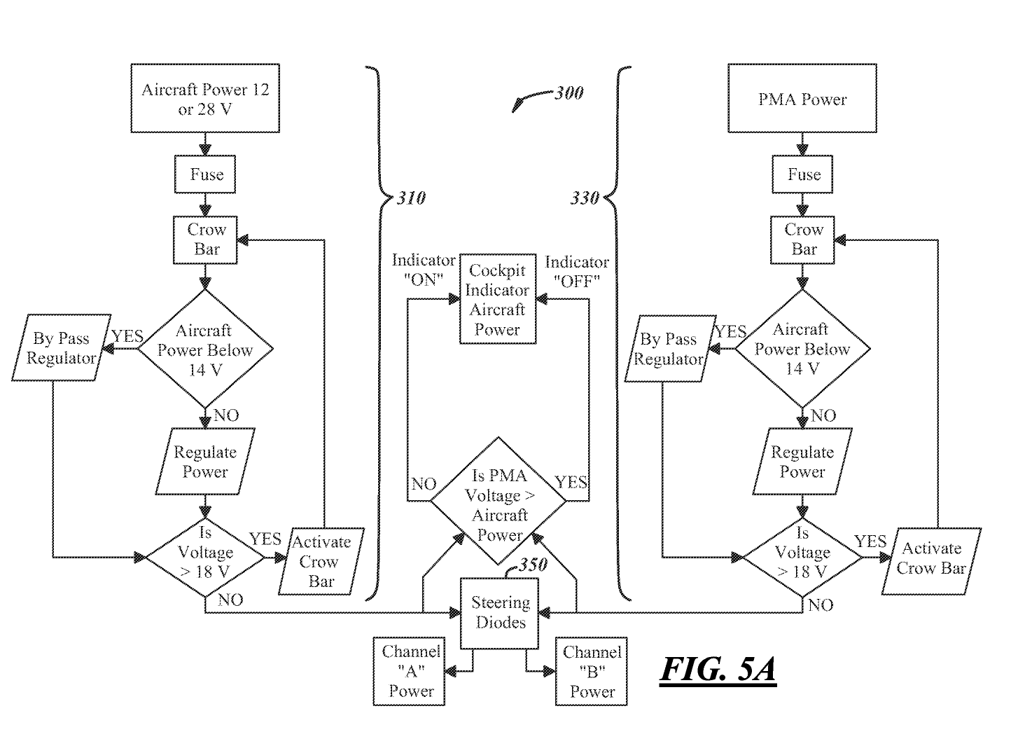

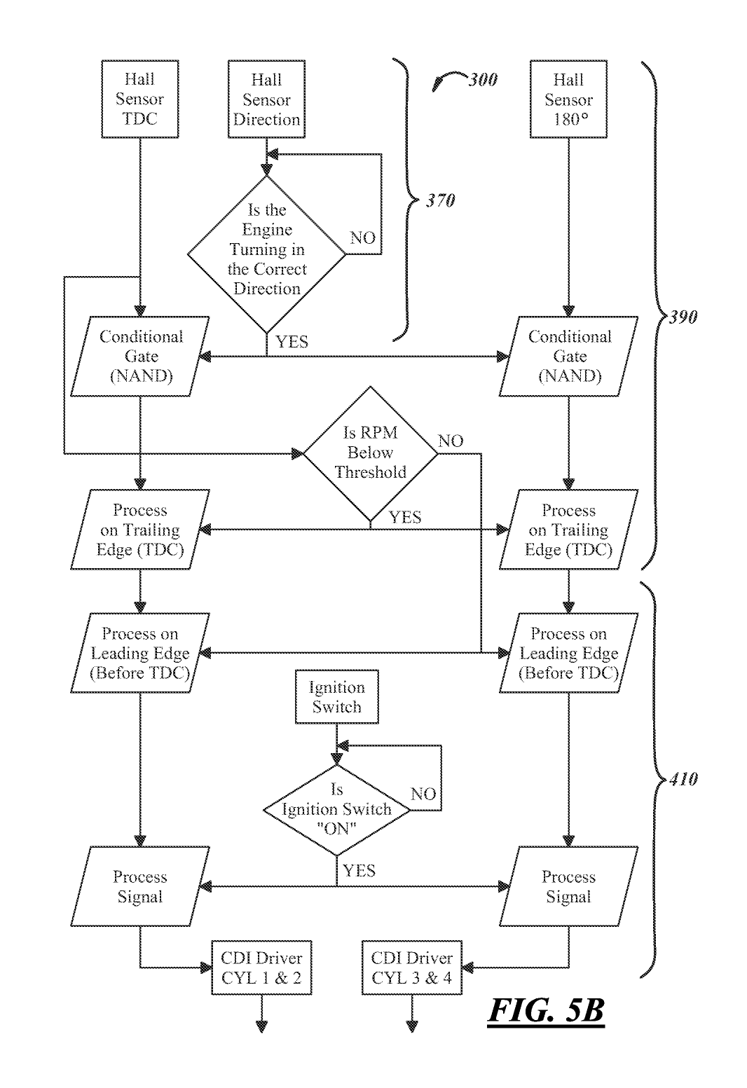

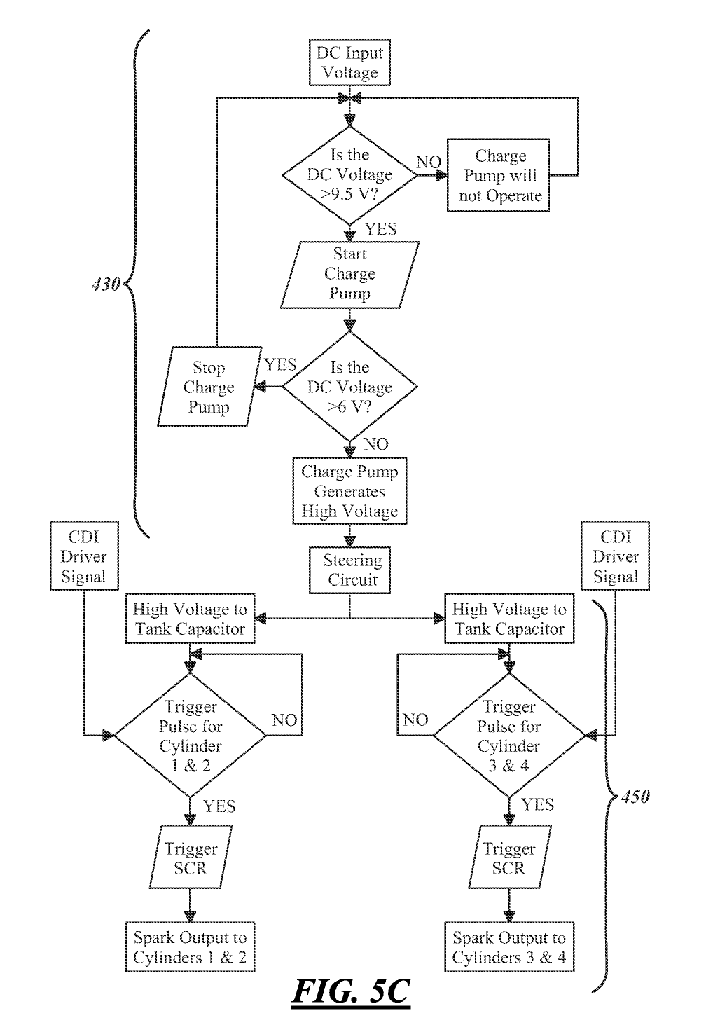

Turning now to FIGS. 5A-C, there is shown an exemplary method 300 for operating an aircraft ignition system, such as the one shown in FIGS. 1A-1D. Skilled artisans will appreciate that while the following description is presented in a linear or sequential format, various steps or groups of steps in method 300 may be executed concurrently or generally concurrently. For example, one or more steps in sequences 310 and 330 may be performed at the same time.

Starting with sequence 310, there are illustrated a number of steps that may be used by power circuit 12 to provide aircraft ignition system 10 with power from aircraft bus 32. As discussed above, aircraft bus 32 provides electrical power to crowbar circuit 36. Assuming that there are no conditions that would activate or trigger crowbar circuit 36 (e.g., an over-voltage condition where the aircraft bus voltage is greater than 18 V), the electrical power passes through voltage regulator circuit 40 and onto isolation circuit 46. If an over-voltage condition exists, then crowbar circuit 36 will short circuit aircraft bus 32 so that it does not damage downstream components. If an under-voltage condition exists (e.g., where the aircraft bus voltage is less than 14 V), then a low voltage bypass feature in voltage regulator circuit 40 is enabled which allows the electrical power to forego the normal channels within the voltage regulator circuit. At the end of sequence 310, electrical power from aircraft bus 32 is presented to the steering diodes of isolation circuit 46, step 350.

A similar sequence of events or steps occurs within sequence 330, except that the electrical power originates from alternator 30, which is mechanically coupled to and runs off of an aircraft engine. At the end of sequence 330, electrical power from alternator 30 is also presented to the steering diodes of isolation circuit 46, step 350. The steering diodes pass or convey the electrical power that has the higher voltage level. To explain, consider the period just following engine start up when the aircraft engine is just warming up and is not yet rotating very fast. During this period, it is likely that the electrical power from aircraft bus 32 has a voltage that exceeds that from alternator 30; thus, step 350 uses the aircraft bus power to drive both power channels 20 and 22 and to fire all of the spark plugs in the engine. At some point, the engine will reach a certain speed (e.g., around 750 RPM) where alternator 30 is outputting a higher voltage than aircraft bus 32; this point is referred to herein as the “handoff point” and broadly refers to the point where aircraft ignition system 10 switches from one power source to the other. If there is a subsequent failure or malfunction with alternator 30, for example, then isolation circuit 46 would recognize the decrease in voltage from that source and would switch back to aircraft bus 32 so that aircraft ignition system 10 is supplied with uninterrupted power. In this way, aircraft ignition system 10 is a self-sustaining ignition system (SSIS) that enjoys redundant power supply from two separate power sources.

With reference to FIG. 5B, exemplary method 300 continues with operation of control circuit 14. As mentioned above, more than one sequence of events or steps may be performed at the same time. The following discussion pertains to the operation of the different control circuit components within power channel 20; however, a similar sequence of events is occurring in power channel 22 which is not repeated here.

Beginning with sequence 370, the method receives an engine direction signal from Hall sensor 170 that indicates the direction in which the engine is rotating. If the engine is not turning in the correct direction, no spark will be generated. During engine start-up or other periods of low engine speed (e.g., less than 350 RPM), control circuit 16 provides an ignition timing without a timing advance (e.g., at TDC or ATDC). This may be accomplished with sequence 390, in which Hall sensor 172 provides an engine speed signal to speed sensing component 180. Depending on whether or not the engine speed is below an engine speed threshold, speed sensing component 180 sends outputs to advanced and non-advanced timing components 182 and 184 (NAND gates in this example) that lock out an ignition timing advance. Accordingly, the only signal that is processed is the one from non-advanced timing component 184 so that the ignition timing occurs as the rotating magnetic element 174 leaves the Hall sensor active area; that is, the rising edge of the sensor output. When the engine speed exceeds the engine speed threshold, speed sensing component 180 changes the bits sent to the NAND gates of components 182 and 184, so that the leading edge of the sensor output triggers the ignition. This corresponds to a timing advance (e.g., 20° BTDC) and is generally represented with sequence 410. A similar sequence of events is taking place in the other power channel 22, which independently generates a second set of trigger signals for firing a second set of spark plugs.

With reference to FIG. 5C, exemplary method 300 continues with operation of discharge circuit 16. As mentioned above, more than one sequences of events or steps may be performed at the same time. The following discussion pertains to the operation of the different discharge circuit components within power channel 20; however, a similar sequence of events is occurring in power channel 22 which is not repeated here. Power channel 20 fires one spark plug in each of the four cylinders, while power channel 22 fires a separate spark plug in each of the four cylinders; thus, a total of eight separate spark plugs are being fired.

Beginning with sequence 430, discharge circuit 16 receives electrical power from power circuit 12 and/or control circuit 14. DC-DC converter 214 steps up the nominal voltage received from power circuit 12 to a higher voltage of, say 250 V. The stepped-up voltage is then provided to trigger circuits 202 and 204. As for trigger circuit 202, the stepped-up voltage is sent to charge capacitor 222 via steering diode 220. Charge capacitor 222 stores the charge until a trigger signal is received from control circuit 14, at which point SCR 224 is turned ‘on’ and discharges or dumps the energy in capacitor 222 through transformer 226, sequence 450. The secondary winding in transformer 226 is connected to spark plugs in the first and second cylinders (these cylinders should be separated by 360°), such that one of these cylinders receives a spark that causes an ignition event and the other cylinder receives a wasted spark. After the engine rotates another 180°, another trigger signal from control circuit 14 is received. This trigger signal, however, activates trigger circuit 204, which in turn fires third and fourth cylinders. It should be kept in mind that a similar sequence of events is simultaneously occurring in a second power channel 22.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. An aircraft ignition system, comprising:
a power circuit having a first power source and a second power source;
a control circuit; and
a discharge circuit,
wherein the power circuit is coupled to the control circuit and the discharge circuit, wherein the control circuit comprises at least one engine sensor for determining engine speed, wherein power is provided by the first power source when the engine speed is at or below an engine speed threshold and provided by the second power source when the engine speed is above the engine speed threshold.

2. The aircraft ignition system of claim 1, wherein the first power source is an aircraft bus and the second power source is an alternator.

3. The aircraft ignition system of claim 2, wherein the alternator is a permanent magnet alternator (PMA).

4. The aircraft ignition system of claim 1, wherein the control circuit and has a plurality of outputs for connection to a plurality of engine cylinders, wherein each cylinder has two spark plugs.

5. The aircraft ignition system of claim 1, wherein the control circuit includes a plurality of engine sensors and a plurality of timing circuits, wherein each engine sensor and each timing circuit controls the ignition timing for a plurality of spark plugs located in different cylinders.

6. The aircraft ignition system of claim 1, wherein the discharge circuit includes a plurality of charge pumps and a plurality of trigger circuits, wherein each charge pump drives a plurality of trigger circuits.

7. The aircraft ignition system of claim 1, wherein the power circuit does not include a magneto for generating power.

8. The aircraft ignition system of claim 1, wherein the control circuit does not include a microprocessor for controlling ignition timing.

9. A method for operating an aircraft ignition system, comprising the steps of:
(a) receiving power from a first power source and a second power source;
(b) firing a plurality of spark plugs with the power from the first power source, wherein the power from the first power source is provided to the plurality of spark plugs via a plurality of power channels; and
(c) firing the same plurality of spark plugs with the power from the second power source, wherein the power from the second power source is provided to the same plurality of spark plugs via the same plurality of power channels.

10. The method of claim 9, further including the step of:
(d) switching from the first power source to the second power source when the second power source provides electrical power at a higher voltage than that of the first power source, and wherein the first power source includes an aircraft bus and the second power source includes an alternator.

11. The method of claim 9, further including the step of:
(e) switching from the first power source to the second power source when an aircraft engine reaches a certain engine speed, wherein the first power source includes an aircraft bus and the second power source includes an alternator.

12. An aircraft ignition system for use with a piston-power engine, comprising:
an electrical circuit, comprising:
a power circuit having two independent power sources, wherein a first power source includes an aircraft bus and a second power source includes an alternator;
a control circuit having a plurality of engine sensors and a plurality of timing circuits; and
a discharge circuit having a plurality of charge pumps and a plurality of trigger circuits, wherein each charge pump drives a plurality of trigger circuits; and
a plurality of spark plugs,
wherein the spark plugs are located in different engine cylinders and coupled to the trigger circuits, wherein the power circuit is coupled to the control circuit and the discharge circuit, wherein the electrical circuit operates in a first mode when the engine speed is within a first range of speeds and the electrical circuit operates in a second mode when the engine speed is within a second range of speeds.

13. The aircraft ignition system of claim 12, wherein the alternator is a PMA.
